(19) United States
(12) Patent Application Publication
(10) Pub. No.: US 2008/0229071 A1
(43) Pub. Date: Sep. 18, 2008

(54) PREFETCH CONTROL APPARATUS, STORAGE DEVICE SYSTEM AND PREFETCH CONTROL METHOD

(75) Inventors: Katsuhiko SHIOYA, Kawasaki (JP); Eiichi YAMANAKA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/042,633

(22) Filed: Mar. 5, 2008

(30) Foreign Application Priority Data
Mar. 13, 2007 (JP) 2007-64026

(51) Int. Cl. G06F 9/30

(52) U.S. Cl. 712/207

(57) ABSTRACT

A prefetch control apparatus includes a prefetch controller for controlling prefetch of read data into a cache memory caching data to be transferred between a computer apparatus and a storage device, and which enhances a read efficiency of the read data from the storage device, a sequentiality decider for deciding whether the read data that are read from the storage device toward the computer apparatus are sequential access data, a locality decider for deciding whether the read data have locality of data arrangement in the predetermined storage area, in a case where the read data that are read from the storage device toward the computer apparatus have been decided not to be sequential access data, and a prefetcher for prefetching the read data in a case where the read data has the locality of the data arrangement.

### BACKGROUND

1. Field

This apparatus, system and method relate to a prefetch control apparatus, a storage device system and a prefetch control method which control the prefetch of read data into a cache memory. The cache memory caches data to be transmitted and received between a computer apparatus and a storage device with a storage medium including a predetermined storage area, thereby enhancing the read efficiency of the read data from the storage device. More particularly, it relates to a prefetch control apparatus, a storage device system and a prefetch control method which prefetch read data even when they are not sequential access data, and which pursue the efficiency of the prefetch, thereby enhancing the read performance of a storage device.

2. Description of the Related Art

With the enhancement of the processing capability of a computer in recent years, the quantity of data which a computer can process has increased steadily, and techniques by which massive data are efficiently read and written between the computer and a storage device have been studied.

There has been known, for example, a storage system called “RAID (Redundant Arrays of Inexpensive Disks)”, in which a plurality of storage devices are managed by a control apparatus in centralized fashion, thereby realizing higher speeds of data read and write, larger capacities of data storage area, and higher reliabilities of data read and write and data storage.

In order to efficiently read and write data, the control apparatus of such a storage system includes, in general, a cache memory. The cache memory stores the write data coming from the computer and the read data going toward the computer temporarily. The cache memory can be accessed at a higher speed than the storage device.

Data which are used frequently are arranged in the cache memory beforehand. In a case where write data coming from the computer into the storage device and read data from the storage device going toward the computer exist in the cache memory, pertinent data processing is executed by accessing the cache memory without accessing the storage device. Thus, the computer can read data from and write data to the storage device efficiently and quickly.

Regarding such a cache memory, a control for performing the reading of data by the computer efficiently and quickly becomes a problem. In a case where the read data are sequential access data, such as vocal data or dynamic image data, the read performance of the storage device can be heightened by prefetching, i.e. reading the sequential access data from the storage device beforehand and storing the prefetched data temporarily in the cache memory.

However, the related-art technique of prefetching is premised on the case in which the read data from the storage device are sequential access data. In a case in which the read data are random access data, on the other hand, the data are not predictable, and hence, the prefetch itself has not been executed.

Besides, in the case of an identical file of high utilization efficiency, the prefetch is sometimes executed even for random access data. However, the only criterion for deciding whether or not to prefetch data in this case is whether the file is an identical file of high utilization efficiency. Therefore, in a case where the data of the identical file are physically dispersed on the disks of a disk system, the efficiency of the prefetch becomes low. Thus, prefetching in this case may actually lower the read performance of the storage device.

### SUMMARY

The device, system and method has for its object to provide a prefetch control apparatus, a storage device system and a prefetch control method in which prefetch is executed even in a case where read data are not sequential access data, and in which the efficiency of the prefetch is optimized, whereby the read performance of a storage device can be enhanced.

The above-described embodiments are intended as examples, and all embodiments are not limited to including the features described above.

### BRIEF DESCRIPTION OF THE DRAWINGS

FIG. 1 is a diagram for explaining the outline and features of the apparatus, system and method;

FIG. 2 is a functional block diagram showing the configuration of a RAID control apparatus according to an embodiment;

FIG. 3 is a diagram showing an example of a cache memory status table;

FIG. 4 is a diagram showing an example of a lun-unit cache hit rate table;

FIG. 5 is a diagram showing an example of a locality monitoring range table;

FIG. 6A is a diagram (#1) showing the outline of a locality decision;

FIG. 6B is a diagram (#2) showing the outline of a locality decision; and

FIG. 7 is a flow chart showing the operations of a prefetch control process.

### DETAILED DESCRIPTION OF THE PREFERRED EMBODIMENTS

Reference may now be made in detail to embodiments, examples of which are illustrated in the accompanying drawings, wherein like reference numerals refer to like elements throughout.

Now, embodiments according to the prefetch control apparatus, the storage device system and the prefetch control method will be described in detail with reference to the accompanying drawings. By the way, in the ensuing embodiments, there shall be illustrated a case where the system is applied to a disk system which is called “RAID” (Redundant Arrays of Inexpensive Disks). In a RAID disk system, a plurality of magnetic disk devices are combined, realizing thereby high speed, large capacity and high reliability.

In this case, the prefetch control apparatus is the control circuit (for example, LSI (Large Scale Integration)) of a RAID control apparatus (RAID controller). The control circuit controls the plurality of magnetic disk devices in centralized fashion, and connects the plurality of magnetic disk devices to a computer apparatus.

By the way, in the embodiments to be described below, there shall be illustrated a case where the storage medium is a magnetic disk, and the magnetic disk device is used as a storage device. However, it is not restricted to the case, but it is also applicable to other storage media and other disk devices such as, for example, an optical disk and an optical disk device, or a magneto-optic disk and a magneto-optic disk device.

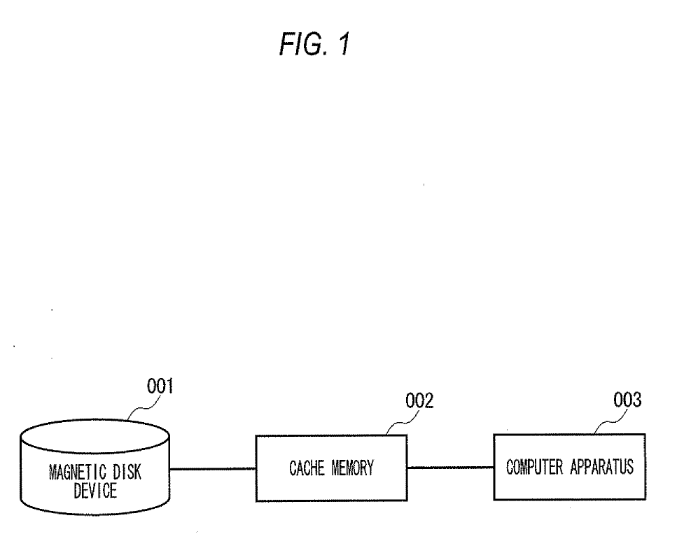

First, the outline and features of one embodiment will be described. FIG. 1 is a diagram for explaining the outline and features of the embodiment. There will be supposed a magnetic disk system in which, as shown in FIG. 1, a computer apparatus 003 and a magnetic disk device 001 are connected through a cache memory 002. In this state, a read request is issued from the computer apparatus 003 to the magnetic disk device 001.

In addition, in a case where read data complying with the read request are random access data, but where the data in the magnetic disk of the magnetic disk device 001 has locality, i.e. are arranged compactly, a prefetch of fixed size and fixed quantity is executed. Here, an expression “random accesses” signifies file accesses in which read/write data have no continuity, and the read/write data having no continuity shall be called the “random access data”. Besides, the expression “locality” signifies that, in the magnetic disk, the data arrangement of the read data lies within a predetermined range set beforehand (for example, within a fixed address range).

Incidentally, an expression “prefetch” means reading data beforehand from the magnetic disk device 001 into the cache memory 002. Reading data beforehand is usually effective in a case where the read data are sequential access data. However, the prefetch of the random access data is based on the fact that, although the random access data have no sequentiality, they are often accessed within a specified range, so they rarely become perfectly random.

In this embodiment, therefore, in a case where the read data complying with the read request from the computer apparatus 003 are not the sequential access data (for example, they are the random access data), but where the data arrangement in the magnetic disk of the magnetic disk device 001 is decided to have locality, the prefetch is executed. Thus, the prefetch can be executed even during random accesses, and the read performance of the data from the magnetic disk device 001 is enhanced.

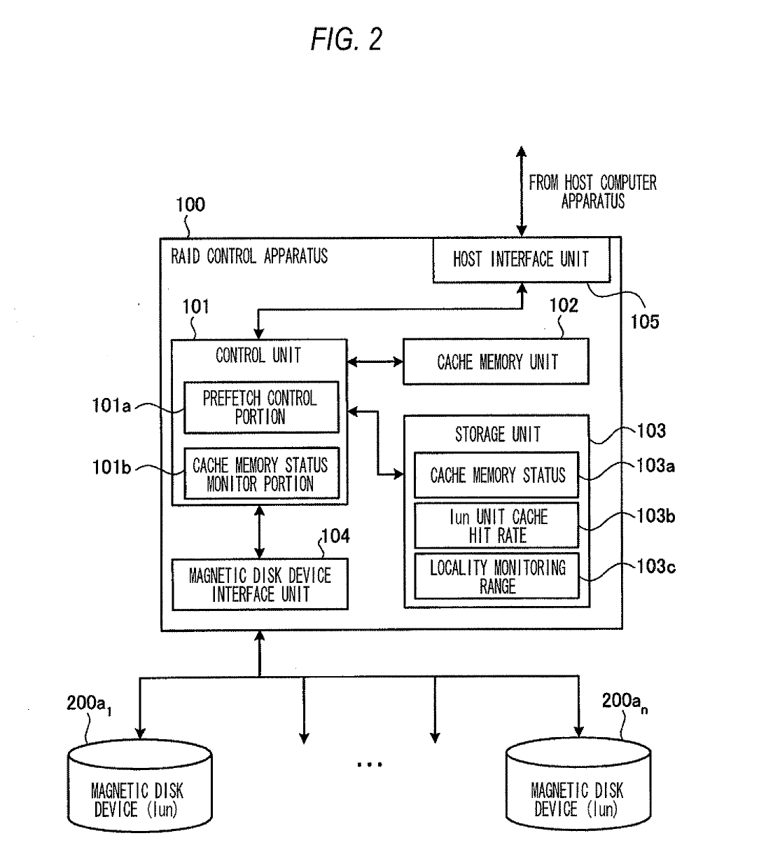

Next, the configuration of the RAID control apparatus according to one embodiment will be described. FIG. 2 is a functional block diagram showing the configuration of the RAID control apparatus according to the embodiment. As shown in FIG. 2, the RAID control apparatus 100 is connected with magnetic disk devices 200a₁, . . . , and 200aₙ and a host computer (not shown). The RAID control apparatus 100 relays read/write data between the magnetic disk devices 200a₁, . . . , and 200aₙ and the host computer. Incidentally, the magnetic disk devices 200aᵢ (i=1, . . . , and n) shall be called the “lun” (logical unit number). Here, the lun is a physical magnetic disk device unit, but it may well be a logical magnetic disk device unit.

The RAID control apparatus 100 includes a control unit 101, a cache memory unit 102, a storage unit 103, a magnetic disk device interface unit 104, and a host interface unit 105. The magnetic disk device interface unit 104 is the interface of data transfer from and to the RAID control apparatus 100. The host interface unit 105 is the interface of data transfer from and to the host computer (not shown).

The control unit 101 is a control unit which governs the control of the whole RAID control apparatus 100. This control unit 101 caches the read data from the magnetic disk devices 200a₁, . . . , and 200aₙ into the cache memory unit 102. The control unit 101 also caches the write data from the host computer into the magnetic disk devices 200a₁, . . . , and 200aₙ into the cache memory unit 102.

As a configuration relevant to the embodiment, the control unit 101 further includes a prefetch control portion 101a and a cache memory status monitor portion 101b. The prefetch control portion 101a decides the randomity and locality of the read data from the magnetic disk devices 200a₁, . . . , and 200aₙ. The prefetch control portion 101a also prefetches the read data so as to cache them into the cache memory unit 102, subject to the decision that the read data have randomity and locality.

Further, in the case where the read data have randomity and locality, the prefetch control portion 101a controls a prefetch quantity in accordance with various conditions stored in the storage unit 103 (the remaining capacity of the cache memory, a cache hit rate, a lun-unit cache hit rate, etc.). Although, in the embodiment, the prefetch quantity to be controlled designates the number of data items to be prefetched, it is not limited to this aspect, but it may well be a data length which is prefetched at one time.

The cache memory status monitor portion 101b monitors the remaining capacity of the cache memory unit 102, and the hit rate of the cache memory. Besides, this portion 101b monitors the hit rate of the cache memory in lun units at all times. The results of such monitors are stored in the predetermined areas of the storage unit 103.

The cache memory unit 102 is a RAM (Random Access Memory) capable of reading and writing data at high speeds, and it temporarily stores (caches) the write data from the host computer not shown, into the magnetic disk devices 200a₁, . . . , and 200aₙ, and the read data from the magnetic disk devices 200a₁, . . . , and 200aₙ. Incidentally, regarding the data which are temporarily stored in the cache memory unit 102, old data are purged (expelled) in conformity with the algorithm of “LRU” (Least Recently Used).

The storage unit 103 is a volatile or nonvolatile storage medium, and it stores therein a cache memory status 103a, a lun-unit cache hit rate 103b and a locality monitoring range 103c. The cache memory status 103a retains the remaining capacity of the cache memory unit 102, and the most recent value and threshold value of the cache hit rate in, for example, a table format. Besides, the lun-unit cache hit rate 103b retains the cache hit rate in lun units, in the cache memory unit 102 in, for example, a table format.

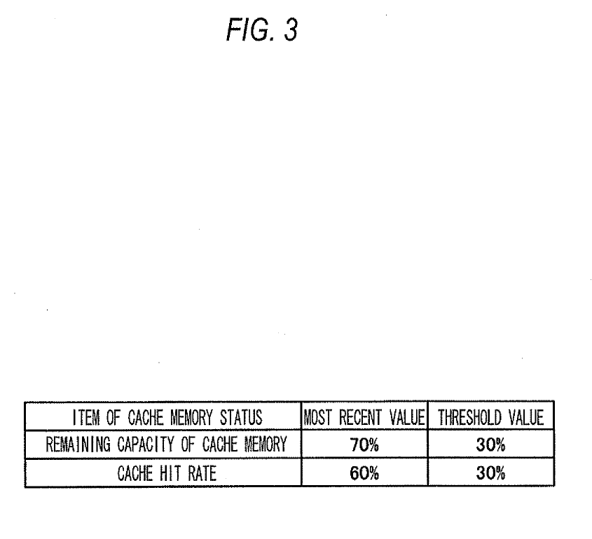

As shown in FIG. 3 by way of example, the table of the cache memory status 103a has the columns of the “item of the cache memory status”, the “most recent value” and the “threshold value”. The “item of the cache memory status” contains the “remaining capacity of the cache memory” and the “cache hit rate”. The “remaining capacity of the cache memory” is expressed by the proportion of the remaining empty capacity of the cache memory to the whole capacity thereof. The “cache hit rate” is expressed by a probability at which, with respect to all input/output requests from the host computer (not shown) toward the magnetic disk devices 200a₁, . . . , and 200aₙ, input/output data complying with the requests have existed in the cache memory unit 102.

The “most recent value” is the newest monitored result based on the cache memory status monitor portion 101b, and it indicates the “cache-memory remaining capacity” or the “cache hit rate” which is always updated every monitoring operation. Besides, the “threshold value” is a criterion value for deciding the quantity of the “cache-memory remaining capacity” or the level of the “cache hit rate”, and it can be set at will from outside.

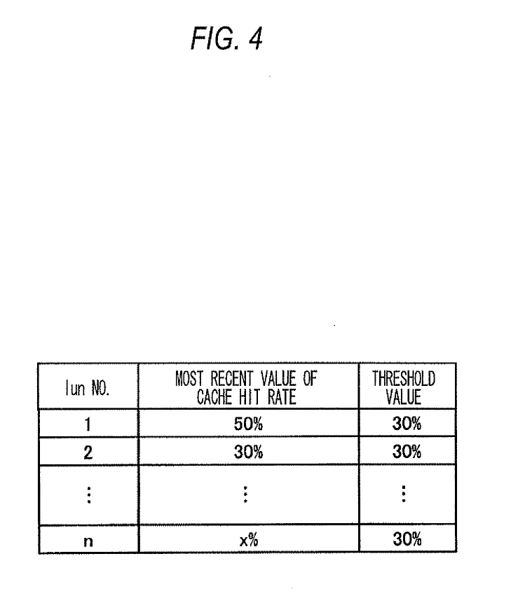

As shown in FIG. 4 by way of example, the table of the lun-unit cache hit rate 103b has the columns of the “lun No.”, the “most recent value of the cache hit rate” and the “threshold value”. The “lun No.” is the device No. of the magnetic disk devices 200a₁, . . . , and 200aₙ. The “most recent value of the cache hit rate” indicates a probability at which, with respect to all input/output requests from the host computer, not shown, toward the magnetic disk devices 200a₁, . . . , and 200aₙ, input/output data complying with the requests have existed in the cache memory unit 102, in lun units. The probability is the newest monitored result based on the cache memory status monitor portion 101b, and it is always updated every monitoring operation. Besides, the “threshold value” is a criterion value for deciding the level of the “most recent value of the cache hit rate”, and it can be set at will from outside.

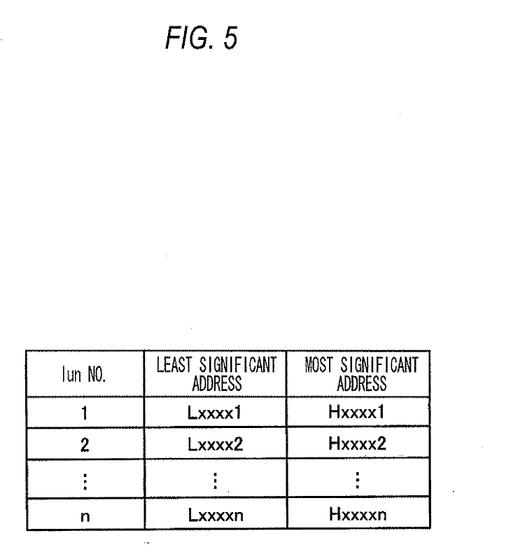

As shown in FIG. 5 by way of example, the table of the locality monitoring range 103c has the columns of the “lun No.”, the “least significant address” and the “most significant address”. The “lun No.” is the device No. of the magnetic disk devices 200a₁, . . . , and 200aₙ. The “least significant address” is the smallest address of the locality monitoring range within which locality is decided to exist in the magnetic disk of the magnetic disk devices 200a₁, . . . , and 200aₙ.

The “most significant address” is the largest address of the locality monitoring range within which locality is decided to exist in the magnetic disk of the magnetic disk devices 200a₁, . . . , and 200aₙ. That is, in a case where the read data are continuously read out from an address range which is determined by the “least significant address” and the “most significant address” of each “lun unit”, these read data and the corresponding read requests (herein below, called the “host IOes (host Inputs/Outputs)” are decided to have locality in the pertinent lun. The “least significant address” and the “most significant address” can be set at will in lun units from outside.

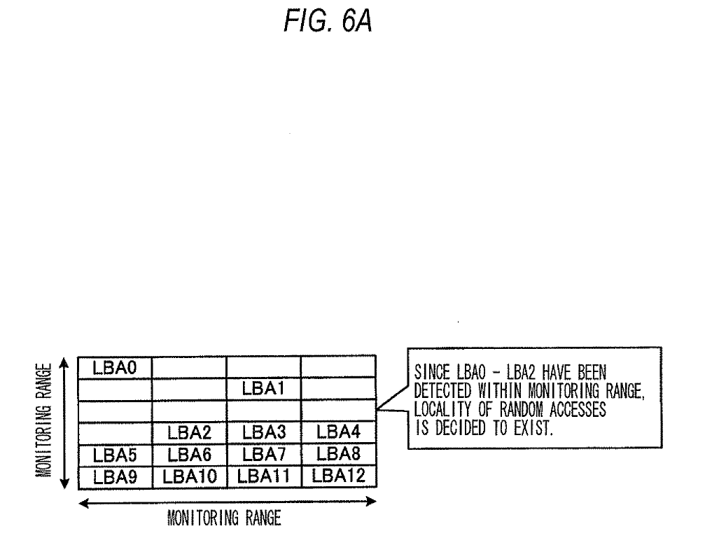

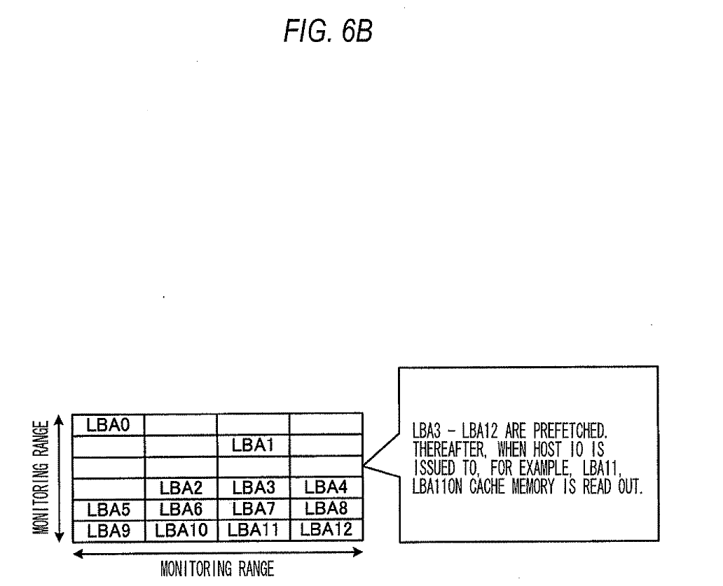

Next, the outline of a locality decision will be described. FIG. 6A is a diagram (#1) showing the outline of the locality decision, while FIG. 6B is a diagram (#2) showing the outline of the locality decision. By the way, in FIGS. 6A and 6B, the unit of the data read from the magnetic disk devices 200a₁, . . . , and 200aₙ is made LBA (Logical Block Addressing) in which a check code of 8 bytes is affixed to data of 512 bytes, and it is set as one time of prefetch size.

First, referring to FIG. 6A, it is assumed that the host IOes of three random accesses being temporally continuous have occurred within a (locality) monitoring range prescribed in lun units in the locality monitoring range 103c, and that respectively corresponding LBAs (logical block addresses) LBA0-LBA2 have been detected on the basis of the host IOes. Therefore, the prefetch control portion 101a decides that the locality of the random accesses exists.

Then, as shown in FIG. 6B, the prefetch control portion 101a prefetches the ten LBAs of addresses LBA3-LBA12. Thereafter, when a host IO is issued to, for example, the address LBA11, the address LBA11 on the cache memory unit 102 is read out.

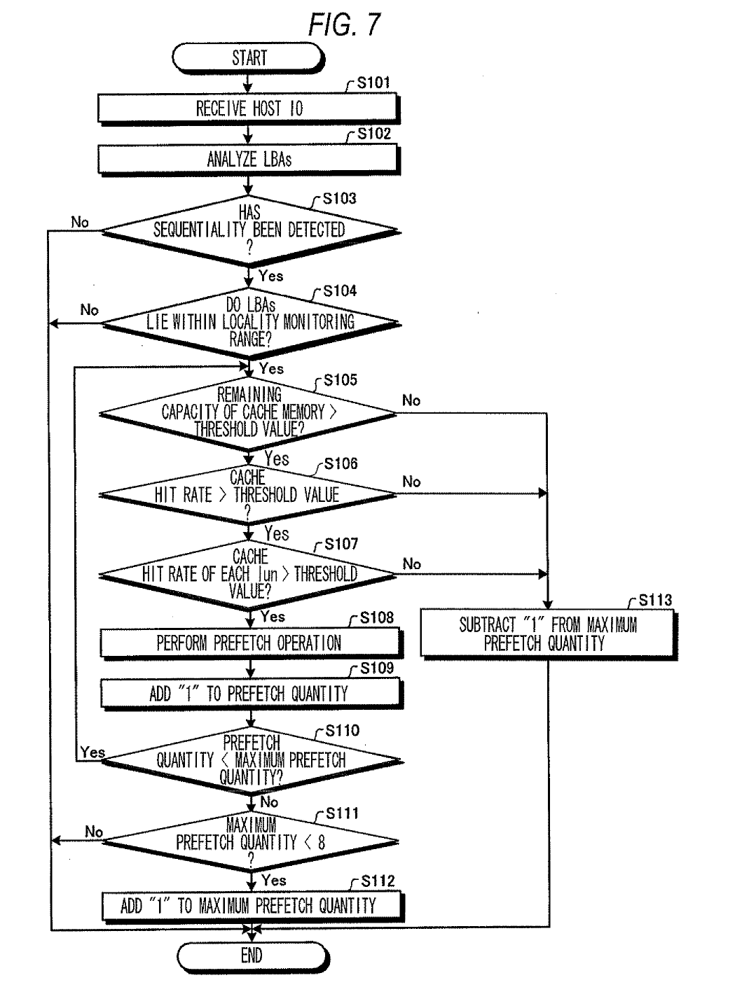

Next, a prefetch control process will be described. FIG. 7 is a flow chart showing the operations of the prefetch control process. Incidentally, as the premise of the prefetch control process, it is assumed that the “maximum prefetch quantity”, the “threshold value of the remaining capacity of the cache memory”, the “threshold value of the cache hit rate”, the “threshold value of the cache hit rate in lun units” and the “locality monitoring range” to be stated later are set beforehand. As shown in the figure, first of all, the prefetch control portion 101a receives a host IO from the host computer (operation S101). Subsequently, the prefetch control portion 101a analyzes the sequentiality of LBAs which have been read out from the magnetic disk devices 200a₁, . . . , and 200aₙ on the basis of the host IO received at the operation S101 (operation S102).

Subsequently, the prefetch control portion 101a decides whether or not the LBAs read out from the magnetic disk devices 200a₁, . . . , and 200aₙ and analyzed at the operation S102 have sequentiality (operation S103). More specifically, when the LBAs do not have continuity as compared with the LBAs of preceding host IOes, random accesses are decided. In a case where the LBAs read out from the magnetic disk devices 200a₁, . . . , and 200aₙ have been decided to have sequentiality (affirmation at the operation S103), the prefetch control process shifts to a operation S104, and in a case where the LBAs read out from the magnetic disk devices 200a₁, . . . , and 200aₙ have not been decided to have sequentiality (negation at the operation S103), the process is ended.

At the operation S104, the prefetch control portion 101a decides whether or not the LBAs read out from the magnetic disk devices 200a₁, . . . , and 200aₙ and analyzed at the operation S102 lie within the preset “locality monitoring range”, in lun units. In a case where the LBAs read out from the magnetic disk devices 200a₁, . . . , and 200aₙ have been decided to lie within the preset “locality monitoring range” (affirmation at the operation S104), the prefetch control process shifts to a operation S105, and in a case where the LBAs read out from the magnetic disk devices 200a₁, . . . , and 200aₙ have not been decided to lie within the preset “locality monitoring range” (negation at the operation S104), the process is ended.

At the operation S105, the prefetch control portion 101a decides whether or not the cache-memory remaining capacity of the cache memory status 103a has exceeded the threshold value. In a case where the cache-memory remaining capacity is decided to have exceeded the threshold value (affirmation at the operation S105), the process shifts to a operation S106, and in a case where the cache-memory remaining capacity is not decided to have exceeded the threshold value (negation at the operation S105), the process shifts to a operation S113.

At the operation S106, the prefetch control portion 101a decides whether or not the cache hit rate of the cache memory status 103a has exceeded the threshold value. In a case where the cache hit rate is decided to have exceeded the threshold value (affirmation at the operation S106), the process shifts to a operation S107, and in a case where the cache hit rate is not decided to have exceeded the threshold value (negation at the operation S106), the process shifts to the operation S113.

At the operation S107, the prefetch control portion 101a decides whether or not the lun-unit cache hit rate of the lun-unit cache hit rate 103b has exceeded the corresponding threshold value. In a case where the cache hit rate in lun units is decided to have exceeded the corresponding threshold value (affirmation at the operation S107), the process shifts to a operation S108, and in a case where the cache hit rate in lun units is not decided to have exceeded the corresponding threshold value (negation at the operation S107), the process shifts to the operation S113.

At the operation S108, the prefetch control portion 101a prefetches one LBA. On this occasion, the prefetch control portion 101a previously checks whether or not the LBA to be prefetched lies within the “locality monitoring range”. In a case where the LBA to be prefetched does not lie within the “locality monitoring range”, the prefetch is not executed. Subsequently, the prefetch control portion 101a adds “1” to a “prefetch quantity” which is a counter variable stored in a predetermined storage area (operation S109).

Subsequently, the prefetch control portion 101a decides whether or not the “prefetch quantity” being the counter variable is less than the “maximum prefetch quantity” which is a counter variable stored in a predetermined storage area (operation S110). Here, the “prefetch quantity” is incremented one by one at the operation S109, and the “maximum prefetch quantity” indicates the limit of the incrementation. In a case where the “prefetch quantity” is decided to be less than the “maximum prefetch quantity” (affirmation at the operation S110), the process shifts to the operation S105, and in a case where the “prefetch quantity” is not decided to be less than the “maximum prefetch quantity” (negation at the operation S110), the process shifts to a operation S111.

At the operation S111, the prefetch control portion 101a decides whether or not the “maximum prefetch quantity” is less than, for example, “8”. Incidentally, the “maximum prefetch quantity” is not limited to the numerical value of “8”, but it can be appropriately set and altered as a numerical value which prescribes the performance of the storage device system. In a case where the “maximum prefetch quantity” is decided to be less than, for example, “8” (affirmation at the operation S111), the prefetch control process shifts to a operation S112, and in a case where the “maximum prefetch quantity” is not decided to be less than, for example, “8” (negation at the operation S111), the process is ended. In addition, at the operation S112, the prefetch control portion 101a adds “1” to the “maximum prefetch quantity”. On the other hand, at the operation S113, the prefetch control portion 101a subtracts “1” from the “maximum prefetch quantity”.

According to the above embodiment, the prefetch can be executed even for random access data. Besides, the prefetch size and prefetch quantity of the prefetch can be dynamically altered in correspondence with the remaining capacity of the cache memory, preventing thereby the depletion of the cache memory and avoiding lowering the performance of the whole system. The “dynamic alterations of the prefetch size and prefetch quantity corresponding to the remaining capacity of the cache memory” signify, for example, that, in a case where the remaining capacity of the cache memory has become less than a threshold value, the prefetch size or prefetch quantity is made small. If the remaining capacity of the cache memory is in excess of the threshold value, on the other hand, the prefetch size or prefetch quantity is made large. Moreover, the embodiment also comprehends stopping the prefetch iwhen the remaining capacity of the cache memory has become extraordinarily small, and resuming the prefetch when the remaining capacity of the cache memory has recovered to some extent.

Although the apparatus, system and method have thus far been described on the embodiments, it is not restricted to the foregoing embodiments, but it may well be performed in various further aspects within the scope of technical ideas defined in the appended claims. Besides, the advantages stated in the embodiments are merely exemplary.

In the foregoing embodiments, the prefetch control apparatus has been the control circuit of the RAID controller. However, the prefetch control apparatus is not restricted to this aspect, but it may well be the RAID controller itself.

Although the storage system has been described as the RAID in the embodiments, it is not restricted to the RAID, but it may well use a single magnetic disk device. Besides, the magnetic disk device may either be externally connected to the computer apparatus or be built in the computer apparatus. In a case where the magnetic disk device is built in the computer apparatus, also the prefetch control apparatus is naturally built in the computer apparatus. Alternatively, it is also allowed to incarnate the prefetch control apparatus by a control unit in the computer apparatus, and to replace the cache memory with an internal storage memory in the computer apparatus.

In the embodiments, the locality monitoring range has been set in such a way that the limits of the most significant digits and least significant digits of addresses in the magnetic disk, for read data designated by a host IO are designated in the locality monitoring range 103c before the operation of the storage device system. However, this aspect is not restrictive, but the most significant digits and least significant digits of the addresses of the magnetic disk as correspond to host IOes issued from the host computer within a fixed time period may well be set as limits. Besides, the locality monitoring range may well be notified from the host computer.

According to the embodiments, in a case where the host IOes of random accesses have been continuously issued, the prefetch is continued, and hence, the hit rate of the cache memory is sometimes enhanced. Whether or not a locality is sustained may well be decided by monitoring the hit rate of the cache memory within a fixed time period.

According to the embodiments, prefetching of logical block addresses (LBAs) is not executed when no continuous host IOes having locality exist within the “locality monitoring range”. Only LBAs which exist within the “locality monitoring range” in a preset prefetch quantity are prefetched. However, this aspect is not restrictive. Rather, the LBAs existing within the “locality monitoring range” may well be prefetched until the preset prefetch quantity is reached, without regard to whether or not continuous host IOes having locality exist within the “locality monitoring range”.

Besides, at least one of the processes described in the embodiments as being automatically performed can be manually performed, or at least one of the processes described as being manually performed can be automatically performed by a known method. Further, information items which contain the processing operations, control operations, concrete designations, and various data and parameters indicated in the embodiments can be altered at will unless specifically stated.

Besides, the individual constituents of the devices shown in the drawings are of functional concepts, and they need not always be physically configured as shown in the drawings. That is, the concrete aspects of the decentralization and integration of the devices are not restricted to the illustrated ones, but all or some of the constituents can be functionally or physically decentralized or integrated in an arbitrary unit in accordance with various loads, the situation of use, etc.

Further, at least one of processing functions which are performed by the individual devices may well be incarnated by a CPU (Central Processing Unit) (or a microcomputer such as MPU (Micro Processing Unit) or MCU (Micro Controller Unit)) and a program which is analyzed and run by the CPU (or the microcomputer such as MPU or MCU), or it may well be incarnated as hardware which is based on wired logic.

Although a few preferred embodiments have been shown and described, it would be appreciated by those skilled in the art that changes may be made in these embodiments without departing from the principles and spirit of the invention, the scope of which is defined in the claims and their equivalents.

What is claimed is:

1. A prefetch control apparatus comprising:
a prefetch control unit to control prefetch of read data into a cache memory which caches data to be transferred between a computer apparatus and a storage device that has a storage medium including a predetermined storage area, and which enhances a read efficiency of the read data from the storage device;
a sequentiality decision unit to decide whether or not the read data that are read from the storage device toward the computer apparatus are sequential access data;
a locality decision unit to decide whether or not the read data have a locality of data arrangement in the predetermined storage area, in a case where the read data that are read from the storage device toward the computer apparatus have been decided not to be the sequential access data, by said sequentiality decision unit; and
prefetch unit to prefetch the read data in a case where the read data have been decided to have the locality of the data arrangement, by said locality decision unit.

2. A prefetch control apparatus as defined in claim 1, further comprising:
a prefetch quantity determination unit to determine a prefetch quantity of the read data on the basis of a predetermined condition, in the case where the read data have been decided to have the locality of the data arrangement, by said locality decision unit;
wherein said prefetch unit prefetches the read data by the prefetch quantity which has been determined by said prefetch quantity determination unit.

3. A prefetch control apparatus as defined in claim 2, wherein said prefetch quantity determination unit decreases the prefetch quantity in a case where an empty capacity of the cache memory is less than a predetermined threshold value, and it increases the prefetch quantity in a case where the empty capacity of the cache memory is not less than the predetermined threshold value.

4. A prefetch control apparatus as defined in claim 3, wherein said prefetch quantity determination unit decreases the prefetch quantity in a case where a hit rate of the cache memory is lower than a predetermined threshold value, and it increases the prefetch quantity in a case where the hit rate of the cache memory is not lower than the predetermined threshold value.

5. A prefetch control apparatus as defined in claim 1, wherein:
the storage device includes a plurality of storage devices; and
said locality decision unit decides whether or not the read data that are read from the storage device toward the computer apparatus have the locality of the data arrangement in the predetermined storage area, for each of the plurality of storage devices.

6. A prefetch control apparatus as defined in claim 5, wherein said prefetch quantity determination unit decreases the prefetch quantity in a case where a hit rate of the cache memory with respect to each of the plurality of storage devices is lower than a predetermined threshold value, and it increases the prefetch quantity in a case where the hit rate of the cache memory with respect to each of the plurality of storage devices is not lower than the predetermined threshold value.

7. A storage device system having a prefetch control apparatus for controlling prefetch of read data into a cache memory which caches data to be transferred between a computer apparatus and a storage device that has a storage medium including a predetermined storage area, and which enhances a read efficiency of the read data from the storage device, comprising:
a sequentiality decision unit to decide whether or not the read data that are read from the storage device toward the computer apparatus are sequential access data;
a locality decision unit to decide whether or not the read data have a locality of data arrangement in the predetermined storage area, in a case where the read data that are read from the storage device toward the computer apparatus have been decided not to be the sequential access data, by said sequentiality decision unit; and
a prefetch unit to prefetching the read data in a case where the read data have been decided to have the locality of the data arrangement, by said locality decision unit.

8. A prefetch control method comprising:
controlling prefetch of read data into a cache memory which caches data to be transferred between a computer apparatus and a storage device that has a storage medium including a predetermined storage area, and which enhances a read efficiency of the read data from the storage device;
deciding whether or not the read data that are read from the storage device toward the computer apparatus are sequential access data;
deciding whether or not the read data have a locality of data arrangement in the predetermined storage area, in a case where the read data that are read from the storage device toward the computer apparatus have been decided not to be the sequential access data; and
prefetching the read data in a case where the read data have been decided to have the locality of the data arrangement.
